(19) United States
(12) Patent Application Publication
(10) Pub. No.: US 2006/0232067 A1
(43) Pub. Date: Oct. 19, 2006

(54) Pipe clamping device

(76) Inventor: Byung-Woon Kwak, Seoul (KR)

Correspondence Address: ARENT FOX PLLC, 1050 CONNECTICUT AVENUE, N.W., SUITE 400, WASHINGTON, DC, 20036, US

(21) Appl. No.: 10/545,805

(22) PCT Filed: Jan. 14, 2004
(86) PCT No.: PCT/KR04/00051

§ 371 Date: Aug. 16, 2005

(30) Foreign Application Priority Data
Feb. 17, 2003 (KR) 20-2003-0004551

(51) Int. Cl. F16L 19/08

(52) U.S. Cl. 285/354; 285/340

(57) ABSTRACT

A pipe clamping device having a stronger gripping force by an elastic deform of a clamp ring during screw-tightening is provided. The pipe clamping device includes at least one clamp ring installed between a female bracket and a male bracket, and made of an elastic material to have a predetermined deform, pressure rings installed in the upper and lower portions of the clamp ring, respectively, and an O-ring formed between the pressure ring and the female bracket and pressurizes the pressure rings to closely contact and seal the pipe. Accordingly a pipe can be easily inserted into and assembled with the clamp ring during an assembly. After assembly, when the female bracket is screw-tightened with the male bracket, the entrance of the blade is narrowed and thus the inner diameter of the clamp ring is also narrowed.

### TECHNICAL FIELD

The present invention relates to a pipe clamping device, and more particularly, to a pipe clamping device having a stronger gripping force by an elastic deform of a clamp ring during screw-tightening.

### BACKGROUND ART

In general, when a pipe and another pipe are connected with each other, a pipe clamping device which bites and fixes pipes is widely used in order to combine the pipes with each other strongly without leaking internal fluid from the pipes.

A conventional pipe clamping device includes a clamp ring which is installed between a female bracket and a male bracket which are screw-tightened with each other, and which is formed of a simplified metal ring shape in which a blade of the clamp ring bites the outer circumferences of pipes in order to prevent the pipes from seceding, and an O-ring which seals a gap between the pipes bitten by the clamp ring.

Here, the clamp ring is forcedly engaged with the pipes, and the blade of the clamp ring is formed slantly in the direction of preventing secession of the pipes. However, the shape of the blade is maintained as it is although a female bracket is screw-tightened with a male bracket. Thus, the inner diameter of the blade is not narrowed.

That is, the clamp ring in the conventional pipe clamping device has only to bite and fix pipes forcibly so that the pipes are not seceded from the clamping device. In other words, a clamping force is not increased by screw-tightening of the female bracket and the male bracket.

Thus, in order to heighten a clamping force of the clamp ring in the conventional pipe clamping device, a compulsive gripping force of catching hold of pipes should be increased.

However, a compulsive engagement work which is performed by inserting pipes into a conventional clamp ring having a small amount of elastic deform and forcedly biting and fixing the pipes with and to the clamp ring with a sufficient gripping force, requires much force in fitting the clamp ring having a narrow entrance diameter with the pipes. Accordingly, it is very difficult to connect and disconnect pipes with and from the clamp ring.

Also, since the outer diameter of the clamp ring should be increased in order to obtain a sufficient gripping force, the outer diameters of the female bracket and the male bracket become large. Thus, the external appearance of the clamping device becomes large and a manufacturing cost is increased.

Also, since the conventional pipe clamping device uses only a single clamp ring, it is difficult to increase a pipe gripping force as desired. In view of designing the pipe clamping device, there is no way to reduce the external diameters of the female and male brackets. As a result, a pipe gripping strength becomes weak.

Also, since the conventional pipe clamping device has a clearance space which allows elastic deform after assembly, a gripping force is lost due to a change in elasticity after assembly to thereby lower a durability, and thus a reliability for performance of a product is lowered.

### DISCLOSURE OF THE INVENTION

To solve the above problems, it is an object of the present invention to provide a pipe clamping device in which a pipe can be easily inserted into and assembled with a clamp ring during an assembly, and after assembly, when a female bracket is screw-tightened with a male bracket, the entrance of the blade of the clamp ring is narrowed and thus the inner diameter of the clamp ring is also narrowed, with a result that a bite strength is increased to enable a strong grip of a pipe and to make it easy to connect and disconnect a pipe with and from the clamping device.

It is another object of the present invention to provide a pipe clamping device in which an outer diameter of a clamp ring can be reduced since a sufficient gripping force can be easily obtained by using an elastic deform of the clamp ring, to accordingly reduce the outer diameters of a female bracket and a male bracket to thereby make the external appearance of a product slimmed and thus save a manufacturing cost.

It is still another object of the present invention to provide a pipe clamping device in which a number of clamp rings are arranged in parallel with each other to thereby increase a pipe gripping force as desired and the outer diameters of the clamp rings can be reduced to thereby greatly reduce the external diameters of the female and male brackets, and to thereby strengthen a pipe gripping force, in view of designing the pipe clamping device.

It is yet another object of the present invention to provide a pipe clamping device having no clearance space which allows elastic deform since the pipe clamping device is screw-tightened after assembly, in which lowering of a durability which is caused by a gripping force lost due to a change in elasticity after assembly can be prevented, and thus a reliability for performance of a product can be enhanced.

To accomplish the above objects of the present invention, according to an aspect of the present invention, there is provided a pipe clamping device which is installed between a female bracket and a male bracket which are connected with each other to fix a pipe, the pipe clamping device comprising: at least one clamp ring which is installed between the female bracket and the male bracket, and made of an elastic material to have a predetermined deform, in which a blade which bites the outer circumference of an inserted pipe is formed around the inner circumference of the clamp ring; pressure rings which are installed in the upper and lower portions of the clamp ring, respectively, in order to pressurize the clamp ring so that the blade of the clamp ring is elastically displaced in the direction of biting and fixing the pipe to thereby create a change in a bite angle when the female bracket is combined with the male bracket to then be screw-tightened; and an O-ring which is formed between the pressure ring and the female bracket and pressurizes the pressure ring and closely contacts and seals the pipe when the female bracket is screw-tightened with the male bracket.

Preferably, the clamp ring comprises a blade on the inner circumference thereof which contacts a pipe and is made of a ring shaped metal main body in which at least one clearance groove is radially disposed from the inner diameter portion to the outer diameter portion so that the diameter of the blade can be elastically extended, with a result that the entrance of the blade can be narrowed during tightening of the clamp ring, the main body is formed to be slant by a predetermined angle with reference to the horizontal surface in a direction of preventing secession of the pipe, and the blade is made of an elastic material which can be elastically deformed so that it is formed to be bent and slant by a predetermined angle with reference to the main body in a direction of preventing secession of the pipe, and the main body is pressurized by the pressure ring and elastically deformed when the female bracket is screw-tightened with the male bracket, with a result that the main body except for the blade is spread out horizontally and thus the inner diameter of the main body is narrowed and a biting degree of the blade becomes deep.

Preferably, the pressure ring is made of a synthetic resin of a circular shape whose upper and lower surfaces are flat in order to pressurize the clamp ring easily, in which at least one clamp ring is installed between the female bracket and the male bracket, and the total height of the pressure ring, the clamp ring and the O-ring is equal to or larger than the height of the space formed between the female bracket and the male bracket.

Preferably, at least two clamp rings are installed in parallel with each other so as to bite a pipe in order to increase a gripping force of the clamp ring and make the external appearance of a product slimmed, in which the sequence of installing the pressure ring, the clamp ring and the O-ring follows a sequence of a female bracket, an O-ring, a pressure ring, a clamp ring, another pressure ring (or a number of spare pressure rings), another clamp ring, the other pressure ring, and a male bracket, so that each clamp ring is enclosed by the pressure rings from top to bottom.

### BRIEF DESCRIPTION OF THE DRAWINGS

The above and other objects and advantages of the present invention will become more apparent by describing the preferred embodiment thereof in more detail with reference to the accompanying drawings in which:

FIG. 1 is an exploded perspective view showing a pipe clamping device according to the present invention;

FIG. 2 is a plan view of a clamp ring of FIG. 1;

FIG. 3 is a side view of the clamp ring of FIG. 2;

FIG. 4 is a plan view showing a pressure ring of FIG. 1;

FIG. 5 is a side view of the pressure ring of FIG. 4;

FIG. 6 is a side cross-sectional view showing a state where the pipe clamping device is assembled and screw-untightened between a female bracket and a male bracket; and

FIG. 7 is a side cross-sectional view showing a state where the pipe clamping device is assembled and screw-tightened between the female bracket and the male bracket.

### BEST MODE FOR CARRYING OUT THE INVENTION

Hereinbelow, a pipe clamping device according to preferred embodiments of the present invention will be described with reference to the accompanying drawings.

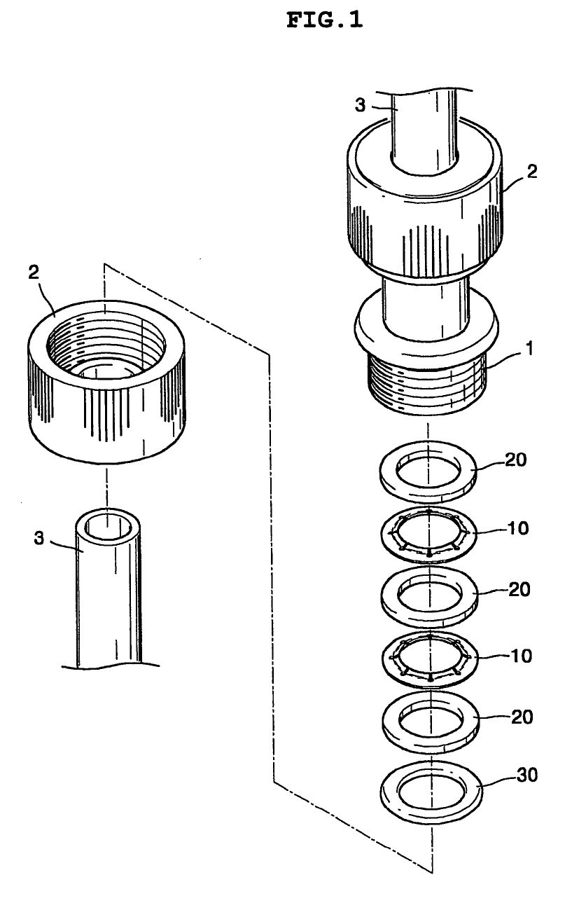

First, as shown in FIG. 1, a pipe clamping device according to a preferred embodiment of the present invention is installed between a female bracket 1 and a male bracket 2 which are coupled with each other, in order to clamp a pipe 3. The pipe clamping device includes a clamp ring 10 which clamps the pipe 3, a pressure ring 20 which pressurizes the clamp ring 10 so that the entrance of the clamp ring 10 is narrowed, and an O-ring 30 which seals the pipe 3.

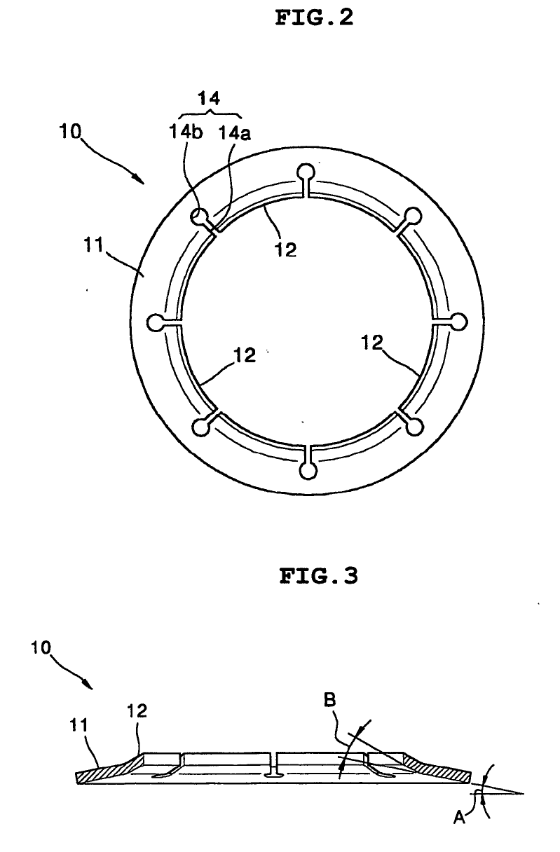

That is, as shown in FIG. 2, the clamp ring 10 is installed between the female bracket 1 and the male bracket 2. A blade 12 which grips the outer circumference of the pipe 3 and fixes the pipe 3, is formed in the inner circumference of the clamp ring 10, and is made of an elastic material so as to be deformed with a predetermined displacement. Further, the clamp ring 10 has the blade 12 at the inner circumference which contacts the pipe 3 and a ring shaped metal main body in which at least one clearance groove is radially disposed in the outer diametrical direction from the inner circumference so that the elastic diameter of the blade 12 can be extended.

Here, as shown in FIG. 2, the clearance groove 14 of the clamp ring 10 includes a linear clearance groove 14a formed in a vertical straight line from the inner diameter in the main body 11 and a circular clearance groove 14b formed extensively in a circle at the end of the linear clearance groove 14a. Accordingly, the elastic gap of the blade 12 can be secured.

Thus, when the blade 12 bites and fixes the outer circumference of the pipe 3, the clamp ring 10 can support the pipe 3 firmly with an appropriate elastic force which is loose in comparison with the non-pressure type conventional art.

Also, as shown in FIG. 3, the main body 11 is formed slantly by a predetermined angle “A” with reference to the horizontal surface in a direction of preventing secession of the pipe 3.

Also, the blade 12 is formed slantly so as to be bent by a predetermined angle “B” with reference to the main body 11 in a direction of preventing secession of the pipe 3. If the female bracket 1 is screw-tightened with the male bracket 2, the main body 11 is pressurized by the pressure ring 20 and elastically deformed. Accordingly, the main body 11 is made of an elastic material which can be elastically deformed so that the main body 11 excluding the blade 12 is spread horizontally and thus the inner diameter of the main body 11 is narrowed to thereby make the biting degree of the blade 12 deeper.

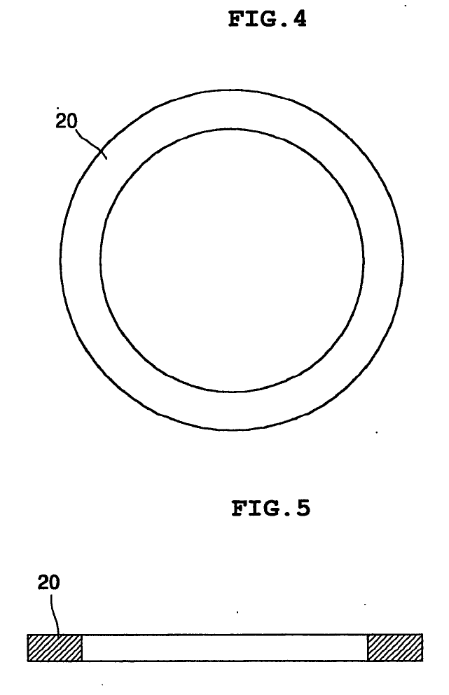

Meanwhile, as shown in FIGS. 4 and 5, the pressure ring 20 is installed in the upper and lower portions of the clamp ring 10, respectively, to thereby pressurize the clamp ring 10, so that if the female bracket 1 is coupled with and screw-tightened with the male bracket 2 so that the main body 11 of the slant clamp ring 10 is spread horizontally and thus the entrance of the clamp ring 10 is narrowed, the blade 12 of the clamp ring 10 is elastically deformed in a direction of biting and fixing the pipe 3 and a biting angle is changed.

The pressure ring 20 is formed of a synthetic resin circular plate shape whose upper and lower surfaces are flat. At least one pressure ring 20 is installed between the female bracket 1 and the male bracket 2 together with the clamp ring 10. The pressure ring 20 plays a role of uniformly dispersing pressure concentrated when the female bracket 1 is screw-tightened with the male bracket 2 into the main body 11 of the clamp ring 10 so that the clamp ring 10 can be horizontally spread. For this purpose, it is preferable that the pressure ring 20 is made of hard metal or synthetic resin having a predetermined rigidness.

Meanwhile, the O-ring 30 is formed between the pressure ring 20 and the female bracket 1. If the female bracket 1 is screw-tightened with the male bracket 2, the O-ring 30 pressurizes the pressure ring 20 and also closely contacts between the pipe 3 and the female bracket 1 to thereby function as a seal.

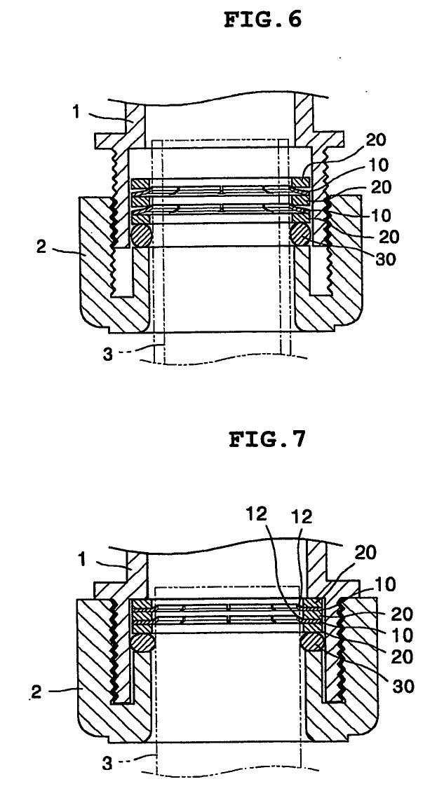

Thus, an assembly state and operational relationship of the pipe clamping device will be described below with reference to FIG. 6. As shown in FIG. 6, the total height of the pressure ring 20, the clamp ring 10 and the O-ring 30 is equal to or larger than the height of the space formed between the female bracket 1 and the male bracket 2. Preferably, at least two clamp rings 10 are installed in parallel with each other so as to bite a pipe 3 and simultaneously the sequence of installing the pressure ring 20, the clamp ring 10 and the O-ring 30 follows a sequence of a female bracket 1, an O-ring 30, a pressure ring 20, a clamp ring 10, another pressure ring 20 (or a number of spare pressure rings), another clamp ring 10, the other pressure ring 20, and a male bracket 2, so that each clamp ring 10 is enclosed by the pressure rings 20 from top to bottom. Then, the female bracket 1 is assembled with the male bracket 2 and prepared to be screw-tightened with the male bracket 2.

Here, since the main body of the clamp ring 10 is inclined, the entrance of the blade 12 in the clamp ring 10, that is, the inner diameter is large so that the pipe 3 can be easily inserted into the clamp ring 10.

Also, as shown in FIG. 7, if the female bracket 1 is completely screw-tightened with the male bracket 2, the O-ring 30 is pressurized by the female bracket 1 and the male bracket 2. Then, the O-ring 30 transfers the pressure to the pressure ring 20.

Then, the pressure ring 20 pressurizes the main body 11 of the clamp ring 10 in a uniformly dispersed manner with the pressure transferred from the O-ring 30. Accordingly, the main body 11 of the clamp ring 10 is horizontally spread.

In this case, the main body 11 of the slant clamp ring 10 is horizontally spread, and simultaneously an elastic deform occurs which narrows the entrance of the blade 12 in the clamp ring 10, that is, the inner diameter occurs. For this reason, loosely bitten pipe 3 is firmly fixed due to biting of the narrowed blade 12, and simultaneously the angle of the blade 12 is maintained as it is, to thereby prevent secession of the pipe 3.

Therefore, if two or more clamp rings 10 are installed and the pressure rings 20 of a variety of thicknesses are installed between the clamp rings 10, the overall biting angle of the clamp rings 10 with respect to the pipe 3 can be further increased. As a result, the clamping strength of the pipe 3 can be adjusted as desired according to the kind of the pipe 3 or the installation conditions of the pipe 3.

Here, since the pipe clamping strength is increased a little in a thickness direction of the external appearances of the female bracket 1 and the male bracket 2 but is not increased in an outer diameter direction, it is possible to accomplish a stepwise increase of the biting strength of the pipe 3 and a very firm fixture of the pipe 3 within the range which does not limit the installation space of the pipe 3.

Also, after screw-tightening of the female bracket 1 and the male bracket 2, a clearance space in which the clamp ring 10 can be additionally deformed disappears owing to the pressure rings 20 which occupy the space. Accordingly, a loosening phenomenon occurring due to lowering of the elasticity of the clamp rings 20 can be prevented.

Besides, it is easy to insert the pipe 3 into the clamp rings 20 during assembly and installation of the pipe 3. Also, if the female bracket 1 is screw-untightened during disassembly of the pipe 3, the main body 11 of the clamp ring 10 is elastically restored so as to be inclined. Accordingly, the inner diameter of the blade 12, that is, the entrance of the blade 12 becomes wider to thereby make it easy to secede the pipe 3.

As described above, in a pipe clamping device according to the present invention, a pipe can be easily inserted into and assembled with a clamp ring during an assembly, and after assembly, when a female bracket is screw-tightened with a male bracket, the entrance of the blade of the clamp ring is narrowed and thus the inner diameter of the clamp ring is also narrowed, with a result that a bite strength is increased to enable a strong grip of a pipe and to make it easy to connect and disconnect a pipe with and from the clamping device.

The pipe clamping device is also provided in which an outer diameter of a clamp ring can be reduced since a sufficient gripping force can be easily obtained by using an elastic deform of the clamp ring, to accordingly reduce the outer diameters of a female bracket and a male bracket to thereby make the external appearance of a product slimmed and thus save a manufacturing cost.

The pipe clamping device is also provided in which a number of clamp rings are arranged in parallel with each other to thereby increase a pipe gripping force as desired and the outer diameters of the clamp rings can be reduced to thereby greatly reduce the external diameters of the female and male brackets, and to thereby strengthen a pipe gripping force, in view of designing the pipe clamping device.

The pipe clamping device is also provided having no clearance space which allows elastic deform since the pipe clamping device is screw-tightened after assembly, in which lowering of a durability which is caused by a gripping force lost due to a change in elasticity after assembly can be prevented, and thus a reliability for performance of a product can be enhanced.

### INDUSTRIAL APPLICABILITY

As described above, the present invention is applied to a pipe clamping device which bites and fixes a pipe.

As described above, the present invention has been described with respect to particularly preferred embodiments. However, the present invention is not limited to the above embodiments, and it is possible for one who has an ordinary skill in the art to make various modifications and variations, without departing off the spirit of the present invention. For example, the shape of the clearance groove in the clamp ring can be formed in a very various form, and also the number of the clamp rings to be installed can be in a variety of figures, Also, the thickness, shape and height of the pressure ring can be variously fabricated. Thus, the protective scope of the present invention is not defined within the detailed description thereof but is defined by the claims to be described later and the technical spirit of the present invention.

1. A pipe clamping device which is installed between a female bracket and a male bracket which are connected with each other to fix a pipe, the pipe clamping device comprising:
at least one clamp ring which is installed between the female bracket and the male bracket, and made of an elastic material to have a predetermined deform so that it is formed to be bent and slant by a predetermined angle, in which a blade which bites the outer circumference of an inserted pipe is formed around the inner circumference of the clamp ring; and
pressure rings which are installed in the upper and lower portions of the clamp ring, respectively, in order to pressurize the clamp ring so that the blade of the clamp ring is elastically displaced in the direction of biting and fixing the pipe to thereby create a change in a bite angle when the female bracket is combined with the male bracket to then be screw-tightened.

2. The pipe clamping device of claim 1, wherein the clamp ring comprises a blade on the inner circumference thereof which contacts a pipe and is made of a ring shaped metal main body in which at least one clearance groove is radially disposed from the inner diameter portion to the outer diameter portion so that the diameter of the blade can be elastically extended, with a result that the entrance of the blade can be narrowed during tightening of the clamp ring, the main body is formed to be slant by a predetermined angle with reference to the horizontal surface in a direction of preventing secession of the pipe, and the blade is made of an elastic material which can be elastically deformed so that it is formed to be bent and slant by a predetermined angle with reference to the main body in a direction of preventing secession of the pipe, and the main body is pressurized by the pressure ring and elastically deformed when the female bracket is screw-tightened with the male bracket, with a result that the main body except for the blade is spread out horizontally and thus the inner diameter of the main body is narrowed and a biting degree of the blade becomes deep.

3. The pipe clamping device of claim 2, wherein the clearance groove of the clamp ring includes a linear clearance groove formed in a vertical straight line from the inner diameter in the main body and a circular clearance groove formed extensively in a circle at the end of the linear clearance groove.

4. The pipe clamping device of claim 1, wherein the pressure ring is formed of a circular shape whose upper and lower surfaces are flat in order to pressurize the inclined main body of clamping ring and change a biting angle, in which at least one pressure ring is installed between the female bracket and the male bracket, and the total height of the pressure ring, the clamp ring and the O-ring is equal to or larger than the height of the space formed between the female bracket and the male bracket.

5. The pipe clamping device of claim 1, further comprising an O-ring which is formed between the pressure ring and the female bracket and pressurizes the pressure ring and closely contacts and seals the pipe when the female bracket is screw-tightened with the male bracket, wherein at least two clamp rings are installed in parallel with each other so as to bite a pipe in order to increase a gripping force of the clamp ring and make the external appearance of a product slimmed, in which the sequence of installing the pressure ring, the clamp ring and the O-ring follows a sequence of a female bracket, an O-ring, a pressure ring, a clamp ring, another pressure ring (or a number of spare pressure rings), another clamp ring, the other pressure ring, and a male bracket, so that each clamp ring is enclosed by the pressure rings from top to bottom.
